(19) United States
(12) Patent Application Publication
(10) Pub. No.: US 2019/0289280 A1
(43) Pub. Date: Sep. 19, 2019

(54) THREE-DIMENSIONAL SENSING MODULE AND COMPUTING DEVICE USING SAME

(71) Applicant: HON HAI PRECISION INDUSTRY CO., LTD., New Taipei (TW)

(72) Inventor: CHEN-KUANG YEH, New Taipei (TW)

(21) Appl. No.: 16/027,326

(22) Filed: Jul. 4, 2018

(30) Foreign Application Priority Data
Mar. 13, 2018 (CN) 201810205418.4

(51) Int. Cl. H04N 13/271; G06T 17/00; G06K 9/00; H04N 13/204

(52) U.S. Cl. CPC H04N 13/271; G06T 17/00; H04N 13/204; G06K 9/00201; G06K 9/00228

(57) ABSTRACT

A 3D sensing module for a computing device includes a base, a depth sensor, a first cover, and a second cover. The module is able to detect different depths and colors of a target object. The base includes a first side portion, a second side portion, and a cross portion. The depth sensor includes first and second depth cameras. The first depth camera is mounted on the first side portion of the base, and the second depth camera is mounted on the second side portion of the base. The first cover covers the first side portion, and the second cover covers the second side portion. The first and second depth cameras can be optically aligned before being mounted together inside the housing of the computing device to ensure a precise and durable mounting.

### FIELD

The present disclosure relates to three-dimensional (3D) sensing by optical means.

### BACKGROUND

A computing device, such as a smart phone, with facial recognition function includes a housing, a depth sensor, and a color camera. The depth sensor and the color camera are mounted inside the housing and at the top front of the computing device to facilitate face recognition when a user looks at the computing device. The depth sensor captures data as to depth of the user's face, and the color camera is configured to capture data as to color of the user's face. The depth sensor includes two depth cameras. The depth cameras and the color camera need to be optically aligned inside the housing. However, optical alignment of the depth cameras and the color camera is often difficult. Additionally, the depth cameras and the color camera may become misaligned due to handling and other everyday forces applied to the computing device.

Accordingly, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a perspective view of an embodiment of a 3D sensing module.

FIG. 2 is a schematic front view of an embodiment of a computing device including the 3D sensing module of FIG. 1.

FIG. 3 is an exploded view of the 3D sensing module of FIG. 1.

FIGS. 4A-4D are perspective views of steps of assembly of the 3D sensing module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

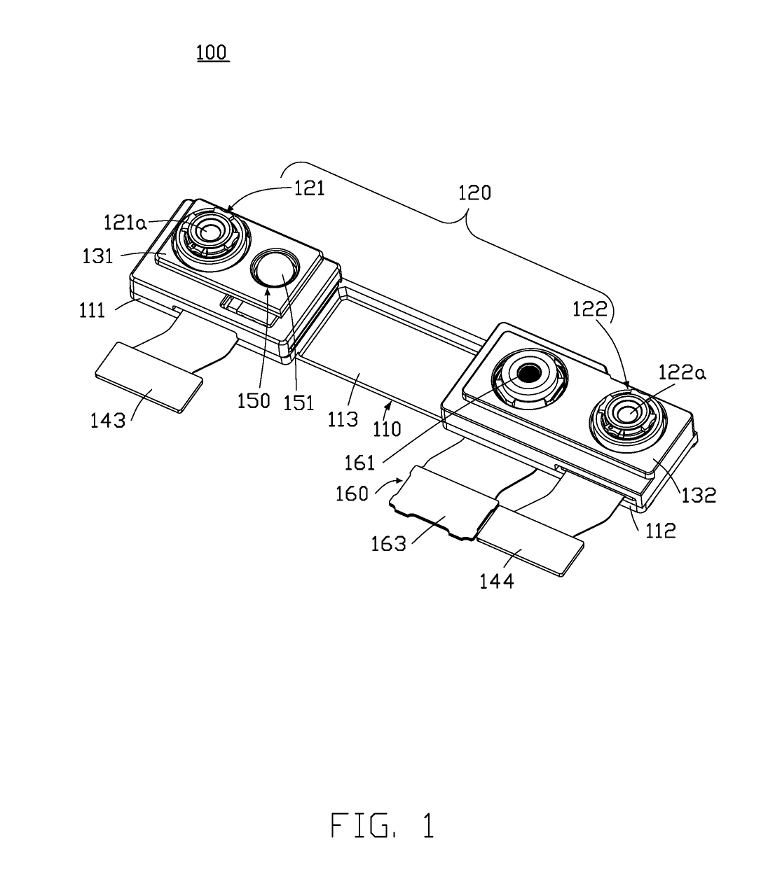

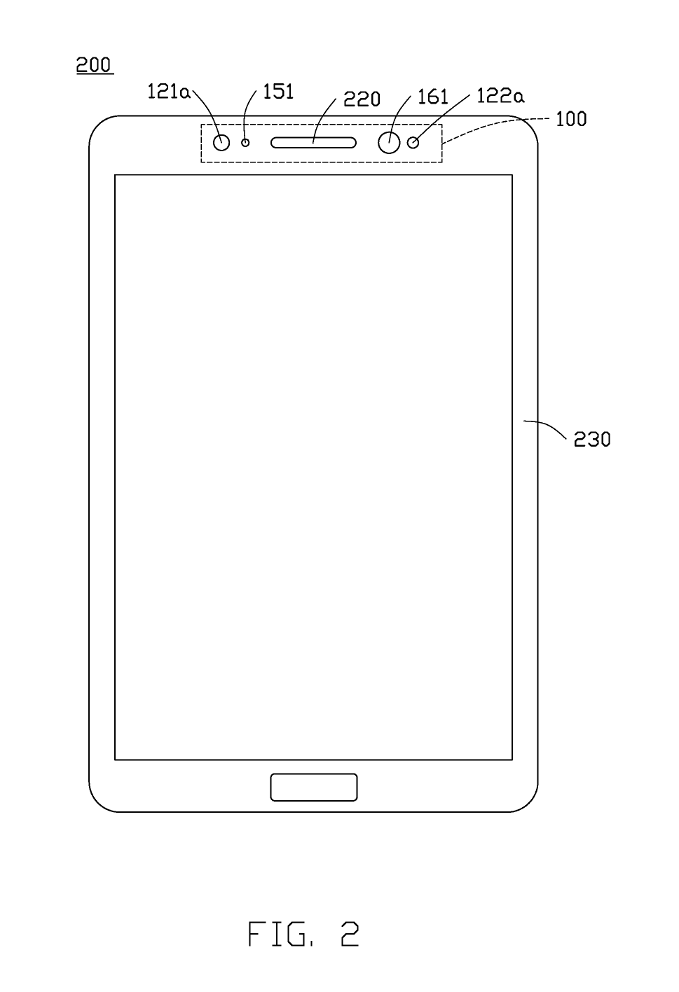

FIGS. 1-2 show a computing device 200 which includes a housing 230, a speaker 220, and a 3D sensing module 100. The computing device 200 may include more or less components than as described. The computing device 200 may be a smart phone, tablet, laptop, or other device. In the present embodiment, the computing device 200 is a smart phone. The 3D sensing module 100, adjacent to the speaker 220, is mounted inside the housing 230 for face recognition of a user looking at the computing device 200.

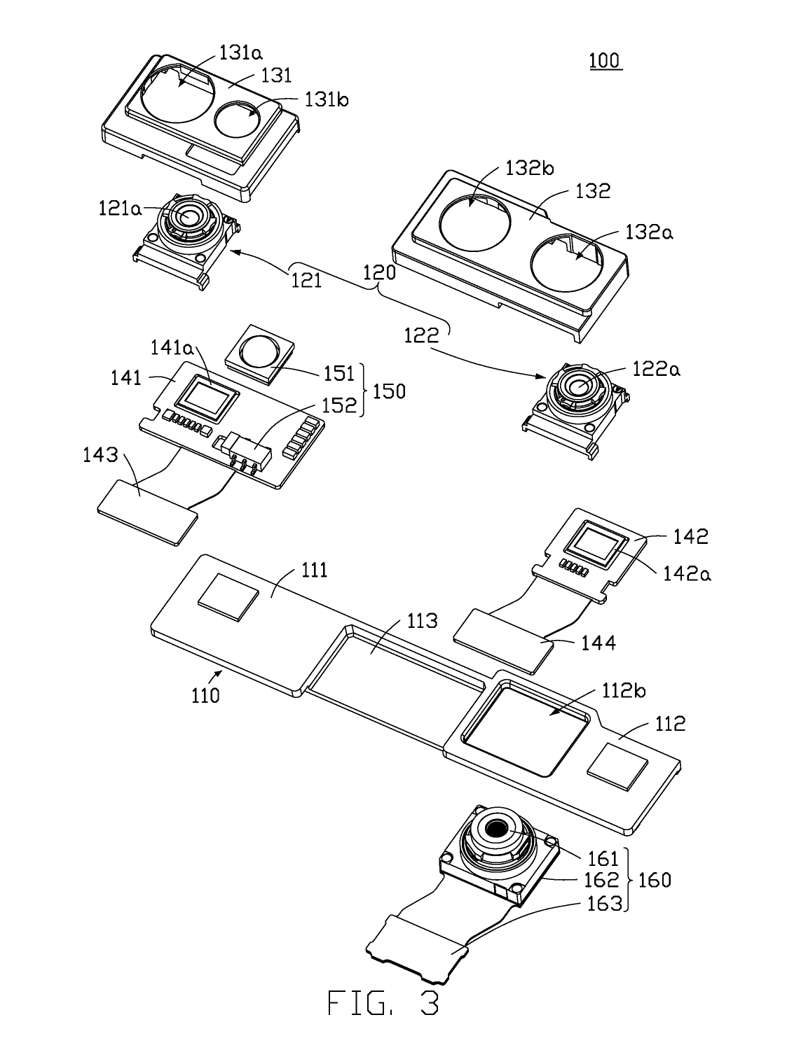

FIGS. 1 and 3 show that the 3D sensing module 100 includes a base 110, a depth sensor 120, a color camera unit 160, a first cover 131, and a second cover 132. The depth sensor 120 and the color camera unit 160 are mounted on the base 110 and are covered by the first cover 131 and the second cover 132 as a modular structure. The base 110, the first cover 131, and the second cover 132 are made of a rigid material, such as metal or hard plastic, that is resistant to deformation.

The base 110 includes a first side portion 111, a second side portion 112, and a cross portion 113. The cross portion 113 is connected between the first side portion 111 and the second side portion 112. The first side portion 111, the cross portion 113, and the second side portion 112 are disposed in a straight line. The second side portion 112 has a mounting hole 112b. The cross portion 113 is recessed for receiving the speaker 220 or other components inside the housing 230.

The depth sensor 120 captures data as to the depth of the user's face. The depth sensor 120 includes a first depth camera unit 121, a second depth camera unit 122, and a light emitting unit 150.

The first depth camera unit 121 includes a first circuit board 141, a first depth camera 121a, and a first connector 143. The first circuit board 141 is mounted on the first side portion 111 of the base 110. The first circuit board 141 has a first circuit board component 141a. The first depth camera 121a is electrically connected to the first circuit board component 141a. The first depth camera 121a is an infrared time-of-flight depth camera. The first connector 143 is electrically connected to the first circuit board 141. The first connector 143 is located outside of the first side portion 111 of the base 110. The first depth camera 121a is electrically connected to components inside the housing 230, through the first connector 143.

The second depth camera unit 122 includes a second circuit board 142, a second depth camera 122a, and a second connector 144. The second circuit board 142 is mounted on the second side portion 112 of the base 110. The second circuit board 142 has a second circuit board component 142a. The second depth camera 122a is electrically connected to the second circuit board component 142a. The second depth camera 122a is an infrared time-of-flight depth camera. The second connector 144 is electrically connected to the second circuit board 142. The second connector 144 is located outside of the second side portion 112 of the base 110. The second depth camera 122a is electrically connected to components inside the housing 230, through the second connector 144.

The light emitting unit 150 includes a light emitter 151 and a light controller 152. The light emitter 151 and the light controller 152 are electrically connected to a side portion of the first circuit board 141. The light emitter 151 is an infrared LED device. The light controller 152 is configured to control the light emitter 151.

The color camera unit 160 is configured to capture data as to color of the user's face. The color camera unit 160 is mounted on the second side portion 112 of the base 110. The color camera unit 160 includes a third circuit board 162, a color camera 161, and a third connector 163. The third circuit board 162 connects the color camera 161 to the third connector 163. The color camera 161 is disposed through the mounting hole 112b of the second side portion 112 of the base 110. The color camera 161 is an RGB camera. The third connector 163 is located outside of the second side portion 112. The color camera 161 is electrically connected to components inside the housing 230, through the third connector 163.

The first cover 131 has a first depth camera receiving opening 131a and a light emitter receiving opening 131b. The first cover 131 covers the first side portion 111 of the base 110 such that the first depth camera 121a is received in the first depth camera receiving opening 131a and the light emitter 151 is received in the light emitter receiving opening 131b.

The second cover 132 has a second depth camera receiving opening 132a and a color camera receiving opening 132b. The second cover 132 covers the second side portion 112 of the base 110 such that the second depth camera 122a is received in the second depth camera receiving opening 132a and the color camera 161 is received in the color camera receiving opening 132b.

The first depth camera 121a, the light emitter 151, the color camera 161, and the second depth camera 122a are disposed in a straight line. The first depth camera 121a, the second depth camera 122a, the color camera 161, and the light emitter 151 can be optically aligned after being mounted on the base 110 and before being mounted inside the housing 230. Optical alignment of the first depth camera 121a, the second depth camera 122a, the color camera 161, and the light emitter 151 can thus be done outside of the housing 230, and more accurately. Additionally, the first depth camera 121a, the second depth camera 122a, the color camera 161, and the light emitter 151 are firmly held in place by the base 110, the first cover 131, and the second cover 132 to avoid displacement/misalignment.

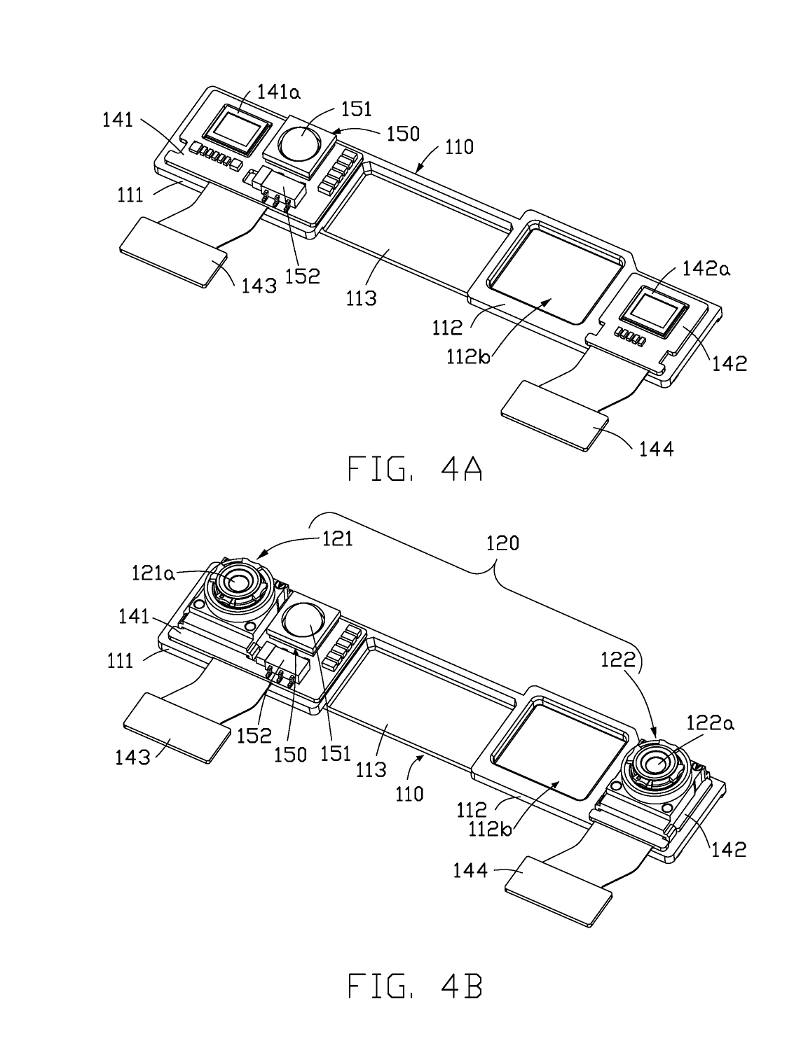

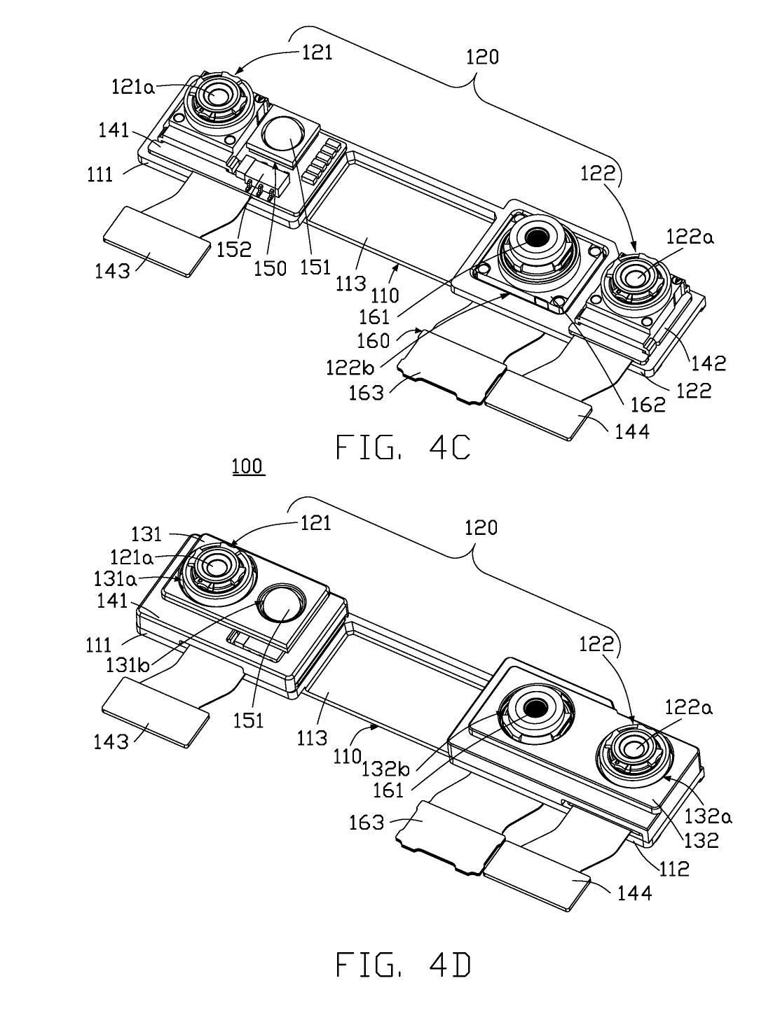

FIGS. 4A-4D show assembly steps of the 3D sensing module 100.

In FIG. 4A, the first circuit board 141 with the first connector 143 and the light emitting unit 150 is mounted on the first side portion 111 of the base 110, and the second circuit board 142 with the second connector 144 is mounted on the second side portion 112 of the base 110.

In FIG. 4B, the first depth camera 121a is connected to the first circuit board component 141a of the first circuit board 141, and the second depth camera 122a is connected to the second circuit board component 142a of the second circuit board 142. The first depth camera 121a, the second depth camera 122a, and the light emitter 151 are then optically aligned.

In FIG. 4C, the color camera unit 160 is mounted on the second side portion 112 of the base 110 such that the color camera 161 is disposed through the mounting hole 112b of the second side portion 112. The color camera 161 is then optically aligned.

In FIG. 4D, the first cover 131 covers the first side portion 111 of the base 110 such that the first depth camera 121a is received in the first depth camera receiving opening 131a and the light emitter 151 is received in the light emitter receiving opening 13 lb. The second cover 132 covers the second side portion 112 of the base 110 such that the second depth camera 122a is received in the second depth camera receiving opening 132a and the color camera 161 is received in the color camera receiving opening 132b, thereby completing the assembly.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A 3D sensing module comprising:
a base comprising:
a first side portion;
a second side portion; and
a cross portion;
a depth sensor comprising:
a first depth camera unit comprising:
a first circuit board mounted on the first side portion of the base; and
a first depth camera connected to the first circuit board; and
a second depth camera unit comprising:
a second circuit board mounted on the second side portion of the base; and
a second depth camera connected to the second circuit board;
a first cover covering the first side portion of the base; and
a second cover covering the second side portion of the base.

2. The 3D sensing module of claim 1, wherein the first side portion, the cross portion, and the second side portion are disposed in a straight line.

3. The 3D sensing module of claim 2, wherein the cross portion is recessed.

4. The 3D sensing module of claim 1,
wherein the first cover has a first depth camera receiving opening in which the first depth camera is received; and
wherein the second cover has a second depth camera receiving opening in which the second depth camera is received.

5. The 3D sensing module of claim 1, wherein the first and second depth cameras are infrared time-of-flight depth cameras.

6. The 3D sensing module of claim 1, further comprising a color camera unit mounted on the second side portion of the base, and the color camera unit comprising a color camera.

7. The 3D sensing module of claim 6, wherein the second cover has a color camera receiving opening in which the color camera is received.

8. The 3D sensing module of claim 6, wherein the color camera is an RGB camera.

9. The 3D sensing module of claim 1, wherein the depth sensor comprises a light emitting unit, and the light emitting unit comprises a light emitter connected to the first circuit board.

10. The 3D sensing module of claim 9, wherein the first cover has a light emitter receiving opening in which the light emitter is received.

11. A computing device comprising:
a housing; and
a 3D sensing module mounted inside the housing, and the 3D sensing module comprising:
a base comprising:
a first side portion;
a second side portion; and
a cross portion;
a depth sensor comprising:
a first depth camera unit comprising:
a first circuit board mounted on the first side portion of the base; and
a first depth camera connected to the first circuit board; and
a second depth camera unit comprising:
a second circuit board mounted on the second side portion of the base; and
a second depth camera connected to the second circuit board;
a first cover covering the first side portion of the base; and
a second cover covering the second side portion of the base.

12. The computing device of claim 11, wherein the first side portion, the cross portion, and the second side portion are disposed in a straight line.

13. The computing device of claim 12, wherein the cross portion is recessed.

14. The computing device of claim 11,
wherein the first cover has a first depth camera receiving opening in which the first depth camera is received; and
wherein the second cover has a second depth camera receiving opening in which the second depth camera is received.

15. The computing device of claim 11, wherein the first and second depth cameras are infrared time-of-flight depth cameras.

16. The computing device of claim 11, wherein the 3D sensing module comprises a color camera unit mounted on the second side portion of the base, and the color camera unit comprises a color camera.

17. The computing device of claim 16, wherein the second cover has a color camera receiving opening in which the color camera is received.

18. The computing device of claim 16, wherein the color camera is an RGB camera.

19. The computing device of claim 11, wherein the depth sensor comprises a light emitting unit connected to the first circuit board, and the light emitting unit comprises a light emitter.

20. The computing device of claim 19, wherein the first cover has a light emitter receiving opening in which the light emitter is received.
